(19) United States
(12) Patent Application Publication
(10) Pub. No.: US 2026/0312696 A1
(43) Pub. Date: Oct. 8, 2026

(54) DRIVER FOR OPTICAL MODULE, CONTROL METHOD, AND OPTICAL MODULE

(71) Applicant: Beijing Zitiao Network Technology Co., Ltd., Beijing (CN)

(72) Inventors: Haohao KANG, Beijing (CN); Lei GUO, Beijing (CN); Feng LUO, Beijing (CN)

(21) Appl. No.: 19/572,790

(22) Filed: Mar. 19, 2026

(30) Foreign Application Priority Data
Mar. 26, 2025 (CN) 202510364903.6

(51) Int. Cl. H04B 10/69

(52) U.S. Cl. CPC H04B 10/6931; H04B 10/6971

(57) ABSTRACT

The present disclosure relates to the technical field of optical modules, and discloses a driver for an optical module, a control method, and an optical module. The driver includes a first detection apparatus, a gain control apparatus, a second detection apparatus, and a regulation apparatus. The first detection apparatus is connected to an input end of the driver, and the first detection apparatus is configured to detect a first signal-to-noise ratio of an input signal of the driver. The gain control apparatus is connected between the input end of the driver and an output end of the driver, and the gain control apparatus is configured to perform gain amplification on the input signal of the driver. The second detection apparatus is connected to the output end of the driver, and the second detection apparatus is configured to detect a second signal-to-noise ratio of an output signal. The regulation apparatus is connected to the first detection apparatus, the second detection apparatus, and the gain control apparatus respectively, and the regulation apparatus is configured to adjust a gain of the gain control apparatus based on the first signal-to-noise ratio and the second signal-to-noise ratio. The present disclosure may solve the problem that it is difficult for a same linear-driver pluggable optics (LPO) to adapt to different ports of a switch.

### CROSS-REFERENCE TO RELATED APPLICATION

The present application is based on and claims priority of CN application No. 202510364903.6, filed on Mar. 26, 2025, the disclosure of which is incorporated herein by reference in its entirety.

### TECHNICAL FIELD

The present disclosure relates to the technical field of optical modules, and in particular, to a driver for an optical module, a control method, and an optical module.

### BACKGROUND

At present, a difference in link length, different ports of a switch have different performances of electrical signals output to a linear-driver pluggable optics (LPO) module.

### SUMMARY

The present disclosure provides a driver for an optical module, a control method, and an optical module.

In a first aspect, the present disclosure provides a driver for an optical module, including:
a first detection apparatus, where the first detection apparatus is connected to an input end of the driver, and the first detection apparatus is configured to detect a first signal-to-noise ratio of an input signal of the driver;
a gain control apparatus, where the gain control apparatus is connected between the input end of the driver and an output end of the driver, and the gain control apparatus is configured to perform gain amplification on the input signal of the driver;
a second detection apparatus, where the second detection apparatus is connected to the output end of the driver, and the second detection apparatus is configured to detect a second signal-to-noise ratio of an output signal of the driver; and
a regulation apparatus, where the regulation apparatus is connected to the first detection apparatus, the second detection apparatus, and the gain control apparatus respectively, and the regulation apparatus is configured to adjust a gain of the gain control apparatus based on the first signal-to-noise ratio and the second signal-to-noise ratio.

In a second aspect, the present disclosure provides a control method for a driver of an optical module, where the control method is applied to a regulation apparatus in the driver, and the regulation apparatus is connected to a first detection apparatus, a gain control apparatus, and a second detection apparatus of the driver respectively; where the first detection apparatus is configured to detect a first signal-to-noise ratio of an input signal of the driver; the gain control apparatus is configured to perform gain amplification on the input signal of the driver; and the second detection apparatus is configured to detect a second signal-to-noise ratio of an output signal of the driver; and the control method includes:
adjusting a gain of the gain control apparatus based on the first signal-to-noise ratio and the second signal-to-noise ratio.

In a third aspect, the present disclosure provides an optical module, including:
an input apparatus, configured to connect to a switch;
the driver according to the first aspect or any corresponding implementation thereof; and
a laser, where a driving end of the laser is connected to an output end of the driver, and the laser is configured to emit an optical signal when driven by an output signal of the driver.

### BRIEF DESCRIPTION OF THE DRAWINGS

In order to more clearly illustrate the technical solutions in the specific implementations of the present disclosure or in the prior art, the following will briefly introduce the drawings that need to be used in the description of the specific implementations or the prior art. Obviously, the drawings in the following description are some implementations of the present disclosure. For those of ordinary skill in the art, other drawings may be obtained based on these drawings without creative efforts.

FIG. 1 is a schematic diagram of a working principle of a linear-driver pluggable optics (LPO) driver according to an embodiment of the present disclosure;

FIG. 2 is a schematic structural diagram of a first driver for an optical module according to an embodiment of the present disclosure;

FIG. 3 is a schematic structural diagram of a second driver for an optical module according to an embodiment of the present disclosure;

FIG. 4 is a schematic structural diagram of a third driver for an optical module according to an embodiment of the present disclosure;

FIG. 5 is a schematic structural diagram of a fourth driver for an optical module according to an embodiment of the present disclosure;

FIG. 6 is a schematic structural diagram of a fifth driver for an optical module according to an embodiment of the present disclosure;

FIG. 7 is a schematic diagram of a gain of a driver in different frequency ranges according to the related art;

FIG. 8 is a schematic diagram of a gain of a driver in different frequency ranges according to an embodiment of the present disclosure;

FIG. 9 is a distribution diagram of an extinction ratio of an 800G LPO module according to the related art;

FIG. 10 is a distribution diagram of an extinction ratio of an 800G LPO module according to an embodiment of the present disclosure; and

FIG. 11 is a structural block diagram of an optical module according to an embodiment of the present disclosure.

The reference numerals are as follows: 1, driver; 11, first detection apparatus; 12, gain control apparatus; 121, gain control module; 1211, first gain unit; 1212, second gain unit; 122, feedforward equalizer; 1221, first filter unit; C1, first capacitor; R1, first resistor; R2, second resistor; 1222, second filter unit; C2, second capacitor; C3, third capacitor; R3, third resistor; R4, fourth resistor; 13, second detection apparatus; 14, regulation apparatus; 15, linear equalizer; 16, baseline wander correction apparatus; 17, output buffer; C4, fourth capacitor; C5, fifth capacitor; 2, laser; 3, input apparatus.

### DETAILED DESCRIPTION OF EMBODIMENTS

In order to make the purpose, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are part of the embodiments of the present disclosure, but not all of them. Based on the embodiments in the present disclosure, all other embodiments obtained by those skilled in the art without creative efforts belong to the protection scope of the present disclosure.

With the rapid development of artificial intelligence (AI), cloud computing, big data and other technologies, large-scale data centers around the world are being upgraded and built, and the demand for high-speed optical modules has soared, which has promoted the capacity of optical modules to gradually evolve to 400G, 800G, and 1.6T.

At present, due to a difference in link length, different ports of a switch have different performances of electrical signals output to a linear-driver pluggable optics (LPO) module, which results in a difference in output signals obtained by a driver in the LPO based on the electrical signals at the different ports, affecting a performance of an optical signal subsequently generated by a laser. A gain set by the driver is a fixed value, which may make it difficult for the LPO to flexibly adjust an output signal of the driver, so that it is difficult for a same LPO to adapt to the different ports of the switch.

At present, mainstream high-speed optical modules mainly process signals through a digital signal processor (DSP) electrical chip to achieve a low bit error rate. The DSP is a high-speed digital processing chip. In addition to providing digital regeneration and clock recovery functions for clock and data recovery (CDR), the DSP may also perform operations such as dispersion compensation, noise reduction, and nonlinear compensation. However, the DSP has high cost, large delay and high power consumption. Therefore, a linear-driver pluggable optics (LPO) module has been proposed in the related art.

The LPO is a pluggable optical module implemented based on a linear-driver chip technology, and the LPO uses a linear analog element on a data link, and has no design scheme of CDR or DSP.

In the driver for the optical module provided by an embodiment of the present disclosure, the first detection apparatus and the second detection apparatus are provided in the driver, and the first detection apparatus is used to detect the first signal-to-noise ratio of the input signal of the driver, and the second detection apparatus is used to detect the second signal-to-noise ratio of the output signal of the driver, so that the regulation apparatus of the driver adjusts the gain of the gain control apparatus based on the first signal-to-noise ratio and the second signal-to-noise ratio. Therefore, a gain used by the gain control apparatus for gain amplification may be adjusted according to a variation relationship of the second signal-to-noise ratio with the first signal-to-noise ratio, so as to adjust a distorted signal to make an output of the gain control apparatus as stable as possible, so that when the first signal-to-noise ratio is high (that is, the input signal of the driver is good), a difference between the second signal-to-noise ratio and the first signal-to-noise ratio is small. When the first signal-to-noise ratio is low, the difference between the second signal-to-noise ratio and the first signal-to-noise ratio is large (that is, the second signal-to-noise ratio is set higher and the output signal of the driver is better), thereby ensuring the stability and consistency of the output signal of the driver under different input signals, and solving the problem of a large difference in driver output of the LPO in different link cases, so that the LPO using the driver of the present disclosure may adapt to different switch systems and different ports of the same switch.

The beneficial effects of the control method for the driver of the optical module and the optical module correspond to the beneficial effects of the driver for the optical module, and details are not described herein again.

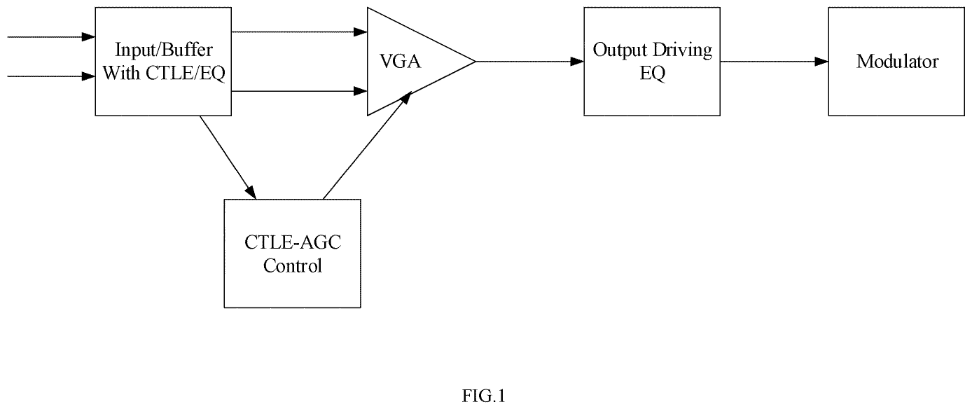

Referring to FIG. 1, FIG. 1 is a schematic diagram of a working principle of a driver of an LPO. The driver of the LPO is an alternative solution to reduce power consumption of a retimer, a DSP or a CDR for a high-speed serializer/deserializer (SerDes) architecture. The LPO relies on the capability of a signal transmitting end SerDes to add a continuous time linear equalization (CTLE)/equalization (EQ) capability to a golden finger input end (Input) or an output buffer (Buffer) of the optical module, and pre-compensates a high-frequency signal input from a front end through the CTLE/EQ. Then, the CTLE and an automatic gain control (AGC) are used to control a variable gain amplifier (VGA) to linearly amplify the input signal. And output drive equalization is performed on the signal output by the VGA to drive a laser to emit an optical signal. Compared with an optical module with a DSP, the LPO may significantly reduce system power consumption and delay.

However, the LPO has general transmission performance and poor interconnection and interoperation. Exemplarily, data comparison between an 800G LPO and an optical module using a DSP is shown in Table 1.

TABLE 1

| | Power | | | Bit error |
|---|---|---|---|---|
| Type | consumption | Delay | Cost | rate |
| 800G DR8 (LPO solution) | ~8.5 W | ~2 ns | Y | 1E−9 |
| 800G DR8 (DSP solution) | ~15.5 W | ~100 ns | 1.4Y | 1E−10 |

As may be seen from Table 1, compared with the DSP solution, the LPO solution has reduced power consumption, delay and cost, but sacrifices the system bit error rate. Therefore, the LPO technology is more dependent on the interactive adaptation with a switch. Under different ports of the switch, since link lengths of the different ports of the switch are different, performances of electrical ports transmitted to the optical module are also different, which affects the output capability of the driver in the LPO, and further affects the performance of an optical port of the LPO.

At present, the driver in the LPO mainly uses a fixed gain, which makes it difficult for a same LPO to adapt to different ports of a same switch or different types of switches. For example, a gain of the driver adapted to a switch of type A is difficult to adapt to a switch of type B.

In view of this problem, the related art mainly focuses on the equalization capability of a continuous time linear equalizer (CTLE) for an input signal and the equalization capability of an automatic gain control (AGC) for an output signal. Ideally, a static output optical eye diagram may reach an optimum. However, limited by the equalization capability of a high-speed analog signal, it is difficult to ensure that the output signal is stabilized in an optimal state due to the change of link input signals of different ports of the switch, whether it is external monitoring intervention or automatic equalization adjustment.

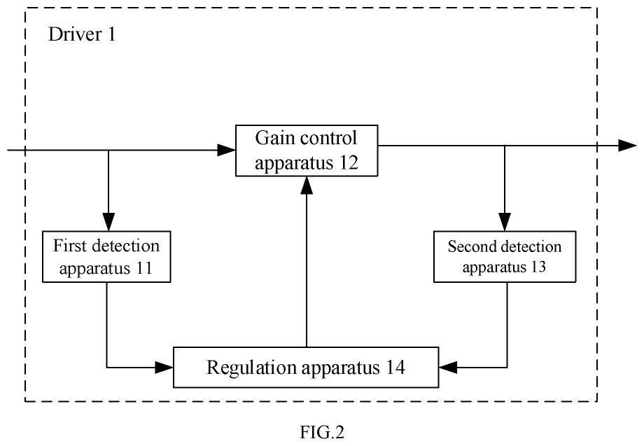

In view of this, an embodiment of the present application provides a driver for an optical module. The optical module referred to in this embodiment is an LPO. Referring to FIG. 2, FIG. 2 shows a schematic structural diagram of a driver for an optical module in this embodiment. As shown in FIG. 2, the driver 1 includes a first detection apparatus 11, a gain control apparatus 12, and a second detection apparatus 13. The first detection apparatus 11 is connected to an input end of the driver 1, and the first detection apparatus 11 is configured to detect a first signal-to-noise ratio (SNR) of an input signal of the driver 1. Specifically, an input end of the first detection apparatus 11 is connected to the input end of the driver 1, and an output end of the first detection apparatus 11 is connected to an input end of the regulation apparatus 14. The first detection apparatus 11 performs blind convergence sorting on the input signal of the driver 1 according to an analog path, and calculates the first SNR.

Specifically, the gain control apparatus 12 is connected between the input end of the driver 1 and an output end of the driver 1, and the gain control apparatus 12 is configured to perform gain amplification on the input signal of the driver 1. An input end of the gain control apparatus 12 is connected to the input end of the driver 1, and an output end of the gain control apparatus 12 is connected to the output end of the driver 1. Optionally, the gain control apparatus 12 uses a two-stage gain amplification circuit (a gain control module 121 described below) with a feedforward equalization (FFE), the gain control apparatus 12 uses automatic gain control, and the gain control apparatus 12 is configured to provide sufficient amplification capability.

Specifically, the second detection apparatus 13 is connected to the output end of the driver 1, and the second detection apparatus 13 is configured to detect a second signal-to-noise ratio of an output signal of the driver 1. An input end of the second detection apparatus 13 is connected to the output end of the gain control apparatus 12, and an output end of the second detection apparatus 13 is connected to the output end of the driver 1. The second detection apparatus 13 is configured to perform fine signal-to-noise ratio detection on the output signal of the driver 1.

In this embodiment, the driver 1 further includes a regulation apparatus 14. The regulation apparatus 14 is connected to the first detection apparatus 11, the second detection apparatus 13, and the gain control apparatus 12 respectively. Specifically, an input end of the regulation apparatus 14 is connected to the output end of the first detection apparatus 11 and the output end of the second detection apparatus 13 respectively, to receive the first signal-to-noise ratio detected by the first detection apparatus 11 and the second signal-to-noise ratio detected by the second detection apparatus 13. A control end of the regulation apparatus 14 is connected to the input end of the gain control apparatus 12 to control the gain of the gain control apparatus 12. Specifically, the regulation apparatus 14 is configured to adjust the gain of the gain control apparatus 12 based on the first signal-to-noise ratio and the second signal-to-noise ratio.

Specifically, the regulation apparatus 14 is configured to adjust the gain of the gain control apparatus 12 based on a variation relationship of the second signal-to-noise ratio with the first signal-to-noise ratio, to dynamically adjust a feedforward pre-emphasis and a de-emphasis in the gain control apparatus 12.

Further, the regulation apparatus 14 is configured to adjust the gain of the gain control apparatus 12 based on the first signal-to-noise ratio and the second signal-to-noise ratio, including: in response that the first signal-to-noise ratio is greater than or equal to a preset threshold, acquiring a difference between the first signal-to-noise ratio and the second signal-to-noise ratio; and in response that the difference exceeds a preset difference range, adjusting the gain of the gain control apparatus 12 to reduce the difference. in response that the difference is within the preset difference range, the adjustment of the gain of the gain control apparatus 12 is stopped.

Further, the regulation apparatus 14 is configured to adjust the gain of the gain control apparatus 12 based on the first signal-to-noise ratio and the second signal-to-noise ratio, further including: in response that the first signal-to-noise ratio and the second signal-to-noise ratio are both less than a preset threshold, adjusting the gain of the gain control apparatus to increase the second signal-to-noise ratio.

Optionally, the preset threshold is 23 dB.

In addition to the above gain adjustment method, the following gain adjustment method may also be used: in response that the second signal-to-noise ratio is less than the preset threshold, adjusting the gain of the gain control apparatus to increase the second signal-to-noise ratio.

It should be noted that, in the process of adjusting the gain of the gain control apparatus, the gain of the gain control apparatus is not adjusted without limit, but an initial gain is set for the gain control apparatus through an original gain control mechanism (for example, constant extinction ratio control). On the basis of the initial gain (that is, within a preset fluctuation range of the initial gain), the regulation apparatus 14 adjusts the gain of the gain control apparatus upwards or downwards to achieve a better second signal-to-noise ratio, thereby stabilizing the output signal of the driver.

In the driver 1 for the optical module provided by this embodiment, the first detection apparatus 11 and the second detection apparatus 13 are provided in the driver 1, and the first detection apparatus 11 is configured to detect the first signal-to-noise ratio of the input signal of the driver 1, and the second detection apparatus 13 is configured to detect the second signal-to-noise ratio of the output signal of the driver 1, so that the regulation apparatus 14 of the driver 1 adjusts the gain of the gain control apparatus 12 based on the first signal-to-noise ratio and the second signal-to-noise ratio. Therefore, the gain used by the gain control apparatus 12 for gain amplification may be adjusted according to the variation relationship of the second signal-to-noise ratio with the first signal-to-noise ratio, so as to adjust the distorted signal to make the output of the gain control apparatus 12 as stable as possible, so that when the first signal-to-noise ratio is high (that is, the input signal of the driver 1 is good), the difference between the second signal-to-noise ratio and the first signal-to-noise ratio is small. When the first signal-to-noise ratio is low, the difference between the second signal-to-noise ratio and the first signal-to-noise ratio is large (that is, the second signal-to-noise ratio is set higher and the output signal of the driver 1 is better), thereby ensuring the stability and consistency of the output signal of the driver 1 under different input signals, and solving the problem of a large difference in output of the driver 1 of the LPO in different link cases, so that the LPO using the driver 1 of the present disclosure may adapt to different switch systems and different ports of the same switch.

In some optional implementations, the gain control apparatus 12 is configured to perform gain amplification on the input signal of the driver 1 based on an initial gain in an initialization stage of the driver 1. The regulation apparatus 14 is further configured to adjust the gain of the gain control apparatus 12 within a preset fluctuation range of the initial gain to increase the second signal-to-noise ratio in the initialization stage.

Further, in the initialization stage, in response that the second signal-to-noise ratio is less than a preset threshold, the gain of the gain control apparatus 12 is adjusted within the preset fluctuation range of the initial gain to increase the second signal-to-noise ratio. For example, the gain of the gain control apparatus 12 is increased to increase the second signal-to-noise ratio. In response that the second signal-to-noise ratio is greater than or equal to the preset threshold, the adjustment of the gain of the gain control apparatus 12 is stopped.

In the driver 1 for the optical module provided by this embodiment, since the gain control apparatus 12 itself has some characteristics (such as noise) that may affect the signal, the gain of the gain control apparatus 12 needs to be adjusted in the initialization stage to increase the second signal-to-noise ratio, thereby shielding the influence of the component itself on the signal, and improving the control precision of the gain control apparatus 12. At the same time, the gain of the gain control apparatus 12 needs to be controlled within the preset fluctuation range of the initial gain to avoid the change of the output signal of the driver 1, so as to maintain the stability of the output signal.

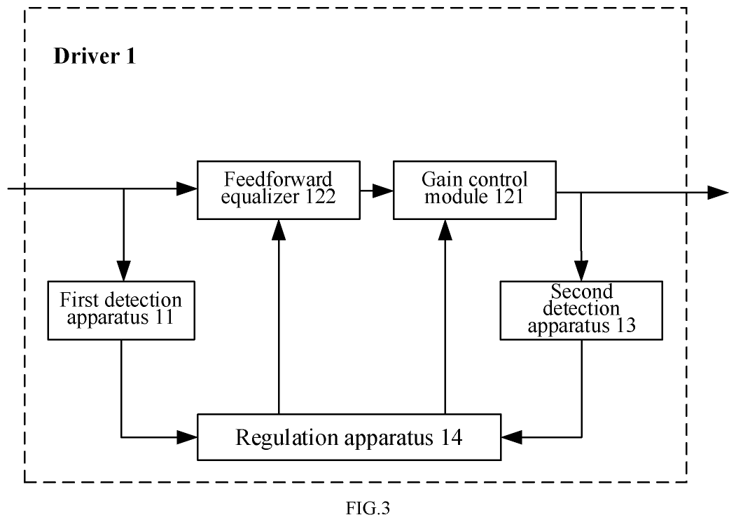

In some optional implementations, as shown in FIG. 3, the gain control apparatus 12 includes a gain control module 121 and a feedforward equalizer 122. An input end of the gain control module 121 is connected to the input end of the driver 1 and the control end of the regulation apparatus 14 respectively, and an output end of the gain control module 121 is connected to the output end of the driver 1. The gain control module 121 is configured to perform gain amplification on the input signal of the driver 1 based on a gain given by the regulation apparatus 14. The feedforward equalizer 122 is connected to the gain control module 121, and the feedforward equalizer 122 is configured to perform equalization processing on an input signal of the gain control module 121.

Specifically, the feedforward equalizer 122 is connected to the input end of the gain control module 121.

Optionally, the gain control module 121 is an automatic gain control (AGC) module.

In the driver 1 for the optical module provided by this embodiment, the feedforward equalizer 122 performs equalization processing on the input signal of the gain control module 121, so that the quality of the input signal of the gain control module 121 may be improved, thereby improving the quality of the output signal amplified by the gain control module 121.

In some optional implementations, the feedforward equalizer 122 includes: a filter unit corresponding to at least one frequency range, where the filter unit is connected to the gain control module 121, and the filter unit is configured to perform filtering processing on a signal in the corresponding frequency range in the input signal of the gain control module 121.

Specifically, the at least one frequency range includes a first frequency range and a second frequency range, where a frequency of the first frequency range is lower than a frequency of the second frequency range. The first frequency range corresponds to a low-frequency signal, and the second frequency range corresponds to an intermediate-frequency signal and a high-frequency signal.

Specifically, the filter unit corresponding to the at least one frequency range includes a first filter unit 1221 and a second filter unit 1222. The first frequency range corresponds to the first filter unit 1221, and the second frequency range corresponds to the second filter unit 1222.

Further, the second frequency range includes a third frequency range and a fourth frequency range. A frequency of the third frequency range is lower than a frequency of the fourth frequency range, the third frequency range corresponds to an intermediate-frequency signal, and the fourth frequency range corresponds to a high-frequency signal.

Specifically, the second filter unit 1222 includes a first sub-filter unit and a second sub-filter unit. The third frequency range corresponds to the first sub-filter unit, and the fourth frequency range corresponds to the second sub-filter unit.

In the driver 1 for the optical module provided by this embodiment, the feedforward equalizer 122 is configured with the filter unit of at least one frequency range, so that the input signals of different frequency ranges in the gain control module 121 may be filtered to further improve the quality of the input signal of the gain control module 121.

In some optional implementations, the regulation apparatus 14 is further connected to the filter unit, and the regulation apparatus 14 is further configured to adjust the gain of the gain control apparatus 12 within the preset fluctuation range of the initial gain to increase the second signal-to-noise ratio in the initialization stage, including: in the initialization stage of the driver 1, adjusting the gain of the gain control module 121 and a filter parameter of the filter unit based on the second signal-to-noise ratio and an output signal of each filter unit. The adjusted gain is within the preset fluctuation range of the initial gain.

Specifically, the regulation apparatus 14 of the present disclosure adjusts the gain of the gain control apparatus 12 based on the first signal-to-noise ratio and the second signal-to-noise ratio only in a normal operation stage. In the initialization stage of the driver 1, the gain of the gain control module 121 and the filter parameter of the filter unit are adjusted based on the second signal-to-noise ratio and the output signal of each filter unit.

Specifically, in the initialization stage, a peak detection signal of the first frequency range of the first filter unit 1221, a peak detection signal of the third frequency range of the first sub-filter unit, and a peak detection signal of the fourth frequency range of the second sub-filter unit are taken and compared with the second signal-to-noise ratio at the same time to obtain one of adjustment input conditions for the gain of the gain control module 121 and the filter parameter of each filter unit. In addition, in the normal operation stage, the first signal-to-noise ratio and the second signal-to-noise ratio are taken as a gain decision condition of another gain control module 121, so that unbalanced control may be implemented through multi-information fusion.

In the driver 1 for the optical module provided by this embodiment, since the gain control module 121 and the filter unit itself have some characteristics (such as noise) that may affect the signal, in the initialization stage, it is necessary to use the second signal-to-noise ratio and the input signal of the frequency range corresponding to the filter unit in the input signal of the gain control module 121 to adjust the gain of the gain control module 121 and the filter parameter of the filter unit, thereby shielding the influence of the component itself on the signal, to improve the control precision of the gain control apparatus 12, and further improve the quality of the output signal of the driver 1.

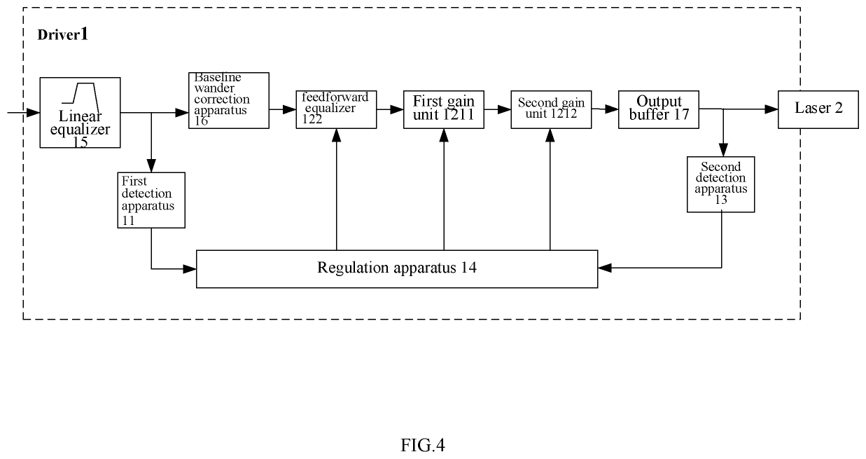

In some optional implementations, as shown in FIG. 4, the gain control module 121 includes a first gain unit 1211 and a second gain unit 1212. An input end of the first gain unit 1211 is connected to an output end of the feedforward equalizer 122 and the control end of the regulation apparatus 14 respectively, and the first gain unit 1211 is configured to perform first-stage gain amplification on the input signal of the driver 1 based on a first gain given by the regulation apparatus 14 to obtain a first-stage amplified signal. An input end of the second gain unit 1212 is connected to an output end of the first gain unit 1211 and the control end of the regulation apparatus 14 respectively, an output end of the second gain unit 1212 is connected to the output end of the driver 1, and the second gain unit 1212 is configured to perform second-stage gain amplification on the first-stage amplified signal based on a second gain given by the regulation apparatus 14.

Specifically, the second gain unit 1212 is configured to perform second-stage gain amplification on the first-stage amplified signal based on the second gain given by the regulation apparatus 14 to obtain the output signal of the driver 1. As shown in FIG. 4, an output buffer 17 is provided between the second gain unit 1212 and the output end of the driver 1. An input end of the output buffer 17 is connected to the output end of the second gain unit 1212, and an output end of the output buffer 17 is connected to the output end of the driver 1, the input end of the second detection apparatus 13, and an input end of the regulation apparatus 14 respectively. The output buffer 17 is configured to amplify the signal output by the second gain unit 1212 to obtain the output signal of the driver 1.

Optionally, the first gain unit 1211 and the second gain unit 1212 use an automatic gain control (AGC) unit.

It may be understood that since the gain brought by one gain unit is relatively small, in practice, it is necessary to configure multiple stages of gain units, such as the first gain unit 1211 and the second gain unit 1212, according to the actual situation to provide more gain adjustment ranges. In practice, in addition to the first gain unit 1211 and the second gain unit 1212, a first gain unit 1211, a second gain unit 1212 and a third gain unit may also be configured in the gain control module 121 to perform gain amplification on the input signal of the driver 1 in stages.

Further, both the first gain unit 1211 and the second gain unit 1212 are provided with an analog front end (AFE). The analog front end includes a pre-emphasis and a de-emphasis.

Optionally, the first gain unit 1211 includes a first analog front end and a first variable gain amplifier (VGA).

Optionally, the second gain unit 1212 includes a second analog front end and a second variable gain amplifier.

In the driver 1 for the optical module provided by this embodiment, two stages of gain units are provided in the gain control module 121, so that more gain adjustment ranges may be provided.

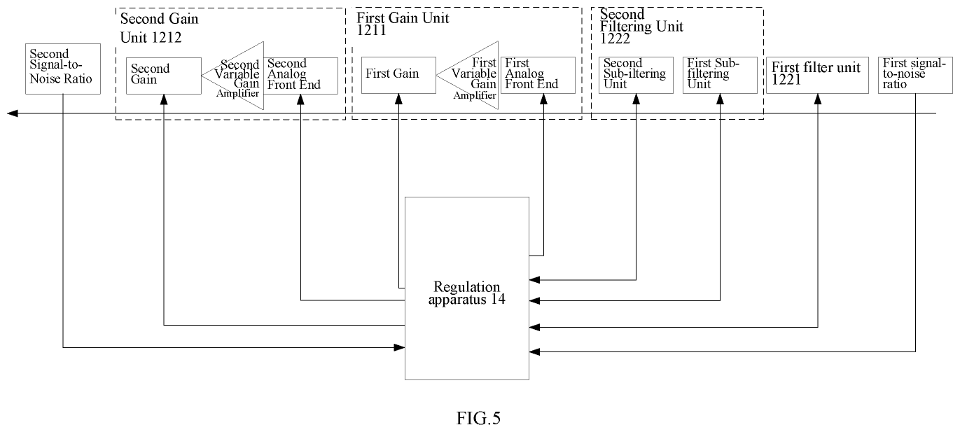

In some optional implementations, as shown in FIG. 5, the feedforward equalizer 122 includes a first filter unit 1221 and a second filter unit 1222. The first filter unit 1221 is connected to the first gain unit 1211, and the first filter unit 1221 is configured to perform filtering processing on a signal in a first frequency range in the input signal of the first gain unit 1211. The second filter unit 1222 is connected to the second gain unit 1212, and the second filter unit 1222 is configured to perform filtering processing on a signal in a second frequency range in the input signal of the second gain unit 1212. A frequency of the first frequency range is lower than a frequency of the second frequency range.

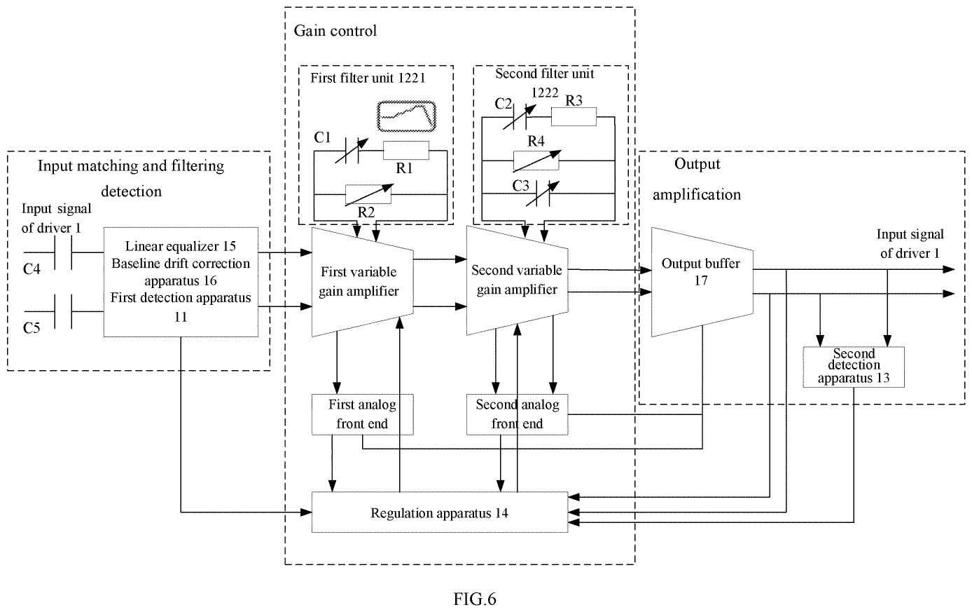

Optionally, as shown in FIG. 6, the first filter unit 1221 includes a first capacitor C1, a first resistor R1, and a second resistor R2. The first capacitor C1 is connected in series with the first resistor R1, and the second resistor R2 is connected in parallel with a circuit where the first capacitor C1 and the first resistor R1 are located.

Optionally, the first capacitor C1 is a variable capacitor, and the first resistor R1 is a variable resistor.

Optionally, as shown in FIG. 6, the second filter unit 1222 includes a second capacitor C2, a third capacitor C3, a third resistor R3, and a fourth resistor R4. The second capacitor C2, the third capacitor C3, and the fourth resistor R4 are connected in parallel, and the second capacitor C2 is connected in series with the third resistor R3.

Optionally, the second capacitor C2 and the third capacitor C3 are variable capacitors, and the fourth resistor R4 is a variable resistor.

It should be noted that the first filter unit 1221 is added to the first variable gain amplifier of the first gain unit 1211, and the second filter unit 1222 is added to the second variable gain amplifier of the second gain unit 1212.

In the driver 1 for the optical module provided by this embodiment, the feedforward equalizer 122 includes the first filter unit 1221 of the first frequency range and the second filter unit 1222 of the second frequency range. The first filter unit 1221 is connected to the first gain unit 1211, and the second filter unit 1222 is connected to the second gain unit 1212. Therefore, the adaptive filtering processing may be performed for the signals for gain amplification in different frequency ranges to ensure the effectiveness of the filtering processing.

In some optional implementations, as shown in FIG. 4, the driver 1 further includes a baseline wander correction (BLWC) apparatus 16. The baseline wander correction apparatus 16 is disposed between the input end of the driver 1 and the gain control apparatus 12, and the baseline wander correction apparatus 16 is configured to perform baseline wander correction on the input signal of the driver 1.

Specifically, an input end of the baseline wander correction apparatus 16 is connected to the input end of the driver 1 and the input end of the first detection apparatus 11 respectively, and an output end of the baseline wander correction apparatus 16 is connected to the input end of the gain control apparatus 12.

Specifically, as shown in FIG. 6, a fourth capacitor C4 and a fifth capacitor C5 are connected to the input end of the driver 1, and the fourth capacitor C4 is parallel to the fifth capacitor C5. The baseline wander correction apparatus 16 is adapted to a pre-input impedance (i.e., the fourth capacitor C4 and the fifth capacitor C5).

In the driver 1 for the optical module provided by this embodiment, the baseline wander correction apparatus 16 uses an additional built-in intermediate-frequency voltage-controlled oscillator (VCO) as a micro-delay line and a peak noise detector to detect the baseline wander, so that the direct current component or the low-frequency drift in the input signal of the driver 1 may be compensated, thereby maintaining the integrity and accuracy of the input signal, and optimizing the background noise of the input signal of the driver 1.

In some optional implementations, as shown in FIG. 4, the driver 1 further includes a linear equalizer 15. An input end of the linear equalizer 15 is connected to the input end of the driver 1, and an output end of the linear equalizer 15 is connected to the first detection apparatus 11 and the input end of the gain control apparatus 12 respectively. The linear equalizer 15 is configured to perform pre-distortion processing on the input signal of the driver 1.

Optionally, the linear equalizer 15 is a continuous time linear equalizer.

Further, the linear equalizer 15 is configured to perform pre-distortion processing on the input signal of the driver 1, including: the linear equalizer 15 performs pre-distortion processing in a full bandwidth range in a manner of a digital signal to compensate for an influence of a channel on the input signal.

In the driver 1 for the optical module provided by this embodiment, the linear equalizer 15 is configured at the input end of the driver 1, so that the linear equalizer 15 may be used to compensate for the influence of the channel on the input signal.

As a specific example, as shown in FIG. 6, the driver 1 for the optical module of the present disclosure includes an input terminal element, a control terminal element, and an output terminal element. The input terminal element includes impedance matching (referring to a fourth capacitor C4 and a fifth capacitor C5 shown in FIG. 6), the linear equalizer 15, the baseline wander correction apparatus 16, and the first detection apparatus 11, and the input terminal element is used for input matching and filtering detection. The control terminal element includes the first filter unit 1221, the second filter unit 1222, the first variable gain amplifier, the second variable gain amplifier, the first analog front end, the second analog front end, and the regulation apparatus 14, and the control terminal element is used to implement peak detection of low-frequency, intermediate-frequency, and high-frequency input signals, and calibrate the parameters of the feedforward equalizer 122 based on the detection signals, and control the gains of the first variable gain amplifier and the second variable gain amplifier. The output terminal element includes the output buffer 17 and the second detection apparatus 13, and the output terminal element is configured to perform signal amplification, output matching, and second signal-to-noise ratio detection on the signal output by the control terminal element.

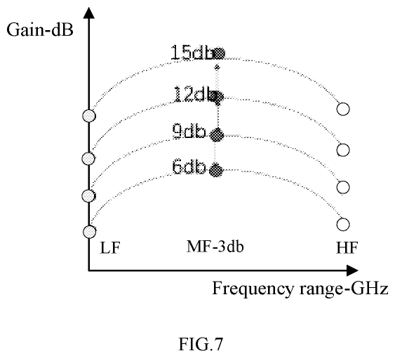

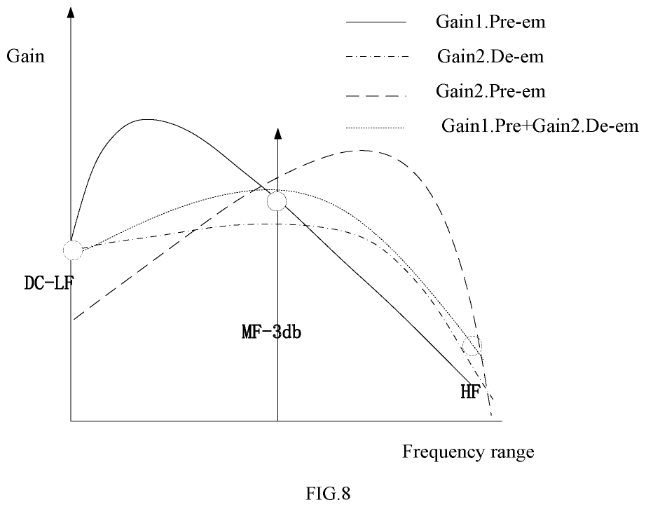

It should be noted that in the related art, a principle of the variable gain amplifier of the driver is to calibrate an intermediate frequency and provide gain adjustment, and a first-stage peaking detector (PKD) is used to achieve gain linear equalization amplification. Referring to the gain in different frequency ranges shown in FIG. 7, it may be seen that when the related art amplifies low-frequency, intermediate-frequency, and high-frequency signals at the same time, the noise suppression capability is poor. After the driver 1 for the optical module of the present disclosure is adopted, referring to the gain Gain1. Pre-em of the pre-emphasis of the first gain unit 1211, the gain Gain2. De-em of the de-emphasis of the second gain unit 1212, the gain Gain2.Pre-em of the pre-emphasis of the second gain unit 1212, and the sum Gain1.Pre-em+Gain2.De-em of the gain of the pre-emphasis of the first gain unit 1211 and the gain of the de-emphasis of the second gain unit 1212 shown in FIG. 8, where Gain1.Pre-em+Gain2.De-em is the desired result of the driver 1 of the present disclosure. It may be seen from Gain1.Pre-em+Gain2.De-em that the output signal of the driver 1 used in the present disclosure under input signals of different frequencies is smooth and stable.

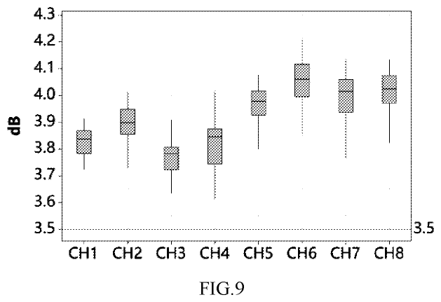

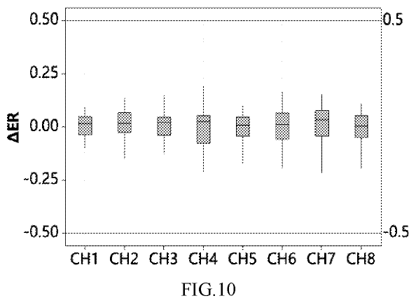

Exemplarily, the extinction ratio of the 800G LPO module using the related art and the extinction ratio of the 800G LPO module using the driver 1 for the optical module of the present disclosure are simulated, and the distribution diagrams of the extinction ratio shown in FIG. 9 and FIG. 10 are obtained respectively. FIG. 9 is a distribution diagram of an extinction ratio (ER) of an 800G LPO module using the related art, and FIG. 10 is a distribution diagram of an extinction ratio of an 800G LPO module using the driver 1 for the optical module of the present disclosure. It may be seen from FIG. 9 that for the 800G LPO module using the related art, the ER distribution has a large dispersion under different channels (such as CH1 to CH8) of the same port. It may be seen from FIG. 10 that the extinction ratio distribution of the 800G LPO module using the present disclosure is relatively convergent. After the driver 1 based on the signal-to-noise ratio automatic gain control of the present disclosure is adopted, the output of the driver 1 of the LPO module has achieved a high degree of consistency. It may be seen that the driver 1 of the present disclosure may solve the problems of the output deviation of the driver 1 and the optical performance deviation caused by the deviation in the case that the electrical port characteristics of different ports of the LPO module are inconsistent.

In this embodiment, there is further provided a control method for a driver 1 of an optical module, which is applied to a regulation apparatus 14 in the driver 1. The regulation apparatus 14 is connected to a first detection apparatus 11, a gain control apparatus 12, and a second detection apparatus 13 of the driver 1 respectively; where the first detection apparatus 11 is configured to detect a first signal-to-noise ratio of an input signal of the driver 1; the gain control apparatus 12 is configured to perform gain amplification on the input signal of the driver 1; and the second detection apparatus 13 is configured to detect a second signal-to-noise ratio of an output signal of the driver 1. For the related description of the driver 1, reference may be made to the above embodiments, and details are not described herein again. A flow of the control method for the driver 1 of the optical module according to the embodiment of the present disclosure includes the following steps: adjusting a gain of the gain control apparatus 12 based on the first signal-to-noise ratio and the second signal-to-noise ratio.

In some optional implementations, the gain control apparatus 12 is configured to perform gain amplification on the input signal of the driver 1 based on an initial gain in an initialization stage of the driver 1. The control method of the present disclosure further includes: in the initialization stage, adjusting the gain of the gain control apparatus 12 within a preset fluctuation range of the initial gain to increase the second signal-to-noise ratio.

Further, the adjusting the gain of the gain control apparatus 12 within the preset fluctuation range of the initial gain to increase the second signal-to-noise ratio includes: in response that the second signal-to-noise ratio is less than a preset threshold, adjusting the gain of the gain control apparatus 12 within the preset fluctuation range of the initial gain to increase the second signal-to-noise ratio; and in response that the second signal-to-noise ratio is greater than or equal to the preset threshold, stopping adjusting the gain of the gain control apparatus 12.

In some other optional implementations, the gain control apparatus 12 includes a gain control module 121 and a feedforward equalizer 122, and the gain control module 121 is configured to perform gain amplification on the input signal of the driver 1 based on a gain given by the regulation apparatus 14. The feedforward equalizer 122 is configured to perform equalization processing on an input signal of the gain control module 121.

Specifically, the feedforward equalizer 122 includes a filter unit corresponding to at least one frequency range, and the filter unit is configured to perform filtering processing on a signal in the corresponding frequency range in the input signal of the gain control module 121.

Further, the regulation apparatus 14 is further connected to the filter unit, and the adjusting the gain of the gain control apparatus 12 within the preset fluctuation range of the initial gain to increase the second signal-to-noise ratio includes: in the initialization stage of the driver 1, adjusting the gain of the gain control module 121 and a filter parameter of the filter unit based on the second signal-to-noise ratio and an output signal of each filter unit. The adjusted gain is within the preset fluctuation range of the initial gain.

The control method of this embodiment adjusts the gain of the gain control apparatus 12 based on the first signal-to-noise ratio and the second signal-to-noise ratio in a normal operation stage.

In some optional implementations, the adjusting the gain of the gain control apparatus 12 based on the first signal-to-noise ratio and the second signal-to-noise ratio includes: in response that the first signal-to-noise ratio is greater than or equal to the preset threshold, acquiring a difference between the first signal-to-noise ratio and the second signal-to-noise ratio; and in response that the difference exceeds a preset difference range, adjusting the gain of the gain control apparatus 12 to reduce the difference.

For example, in response that the difference between the first signal-to-noise ratio and the second signal-to-noise ratio exceeds the preset difference range, the gain of the gain control apparatus 12 is increased to increase the second signal-to-noise ratio. In practical applications, in order to maintain the stability of the output signal of the driver 1, the increased gain needs to be within the preset fluctuation range of the initial gain.

Further, in response that the difference between the first signal-to-noise ratio and the second signal-to-noise ratio is within the preset difference range, the adjustment of the gain of the gain control apparatus 12 is stopped.

In some optional implementations, the adjusting the gain of the gain control apparatus 12 based on the first signal-to-noise ratio and the second signal-to-noise ratio further includes: in response that the first signal-to-noise ratio and the second signal-to-noise ratio are both less than the preset threshold, adjusting the gain of the gain control apparatus 12 to increase the second signal-to-noise ratio.

For example, in response that the first signal-to-noise ratio and the second signal-to-noise ratio are both less than the preset threshold, the gain of the gain control apparatus 12 is increased to increase the second signal-to-noise ratio.

It may be understood that in response that the first signal-to-noise ratio is less than the preset threshold, it indicates that the quality of the input signal is poor. At this time, it is necessary to adjust the gain of the gain control apparatus 12 to increase the second signal-to-noise ratio, thereby improving the quality of the output signal.

Further, in response that the second signal-to-noise ratio is greater than or equal to the preset threshold, the adjustment of the gain of the gain control apparatus 12 is stopped.

Optionally, the preset threshold is 23 dB.

It should be noted that the overall control flow of the control method of the present disclosure is as follows: in the initialization stage of the driver 1, the gain control apparatus 12 uses the initial gain to perform gain amplification on the input signal of the driver 1. At the same time, the second detection apparatus 13 detects the second signal-to-noise ratio of the output signal of the driver 1. The gain of the gain control apparatus 12 is adjusted within the preset fluctuation range of the initial gain to increase the second signal-to-noise ratio, so that the second signal-to-noise ratio is greater than the preset threshold (such as 23 dB). In the normal operation stage, the gain control apparatus 12 uses the gain determined in the initialization stage to perform gain amplification on the input signal of the driver 1. At the same time, the first detection apparatus 11 detects the first signal-to-noise ratio of the input signal of the driver 1, and the second detection apparatus 13 continues to detect the second signal-to-noise ratio of the output signal of the driver 1. In response that the first signal-to-noise ratio is greater than or equal to the preset threshold, and in response that the difference between the first signal-to-noise ratio and the second signal-to-noise ratio exceeds the preset difference range, the gain of the gain control apparatus 12 is adjusted to reduce the difference until the difference between the first signal-to-noise ratio and the second signal-to-noise ratio is within the preset difference range. In response that the first signal-to-noise ratio and the second signal-to-noise ratio are both less than the preset threshold, the gain of the gain control apparatus 12 is adjusted to increase the second signal-to-noise ratio until the second signal-to-noise ratio is greater than or equal to the preset threshold.

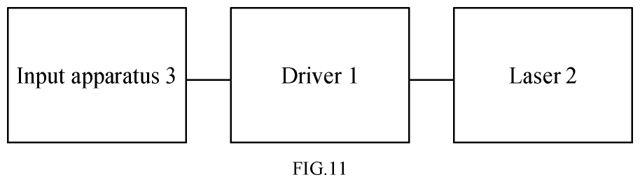

An embodiment of the present disclosure further provides an optical module. As shown in FIG. 11, the optical module includes an input apparatus 3, the driver 1 in the above embodiment, and a laser 2.

Specifically, the input apparatus 3 is configured to connect to a switch. The input apparatus is a golden finger.

Specifically, an input end of the driver 1 is connected to the input apparatus 3. For the related description of the driver 1, reference may be made to the description of the driver 1 for the optical module above, and details are not described herein again.

Specifically, a driving end of the laser 2 is connected to an output end of the driver 1, and the laser 2 is configured to emit an optical signal under the driving of the output signal of the driver 1.

Optionally, the laser 2 may be a vertical-cavity surface-emitting laser (VCSEL) 2, an electro-absorption modulated laser (EML) 2, a Mach-Zehnder modulator (MZM), and other lasers.

Although the embodiments of the present disclosure are described in combination with the drawings, those skilled in the art may make various modifications and variations without departing from the spirit and scope of the present disclosure, and such modifications and variations fall within the scope defined by the appended claims.

1. A driver for an optical module, comprising:
a first detection apparatus, wherein the first detection apparatus is connected to an input end of the driver, and the first detection apparatus is configured to detect a first signal-to-noise ratio of an input signal of the driver;
a gain control apparatus, wherein the gain control apparatus is connected between the input end of the driver and an output end of the driver, and the gain control apparatus is configured to perform gain amplification on the input signal of the driver;
a second detection apparatus, wherein the second detection apparatus is connected to the output end of the driver, and the second detection apparatus is configured to detect a second signal-to-noise ratio of an output signal of the driver; and
a regulation apparatus, wherein the regulation apparatus is connected to the first detection apparatus, the second detection apparatus, and the gain control apparatus respectively, and the regulation apparatus is configured to adjust a gain of the gain control apparatus based on the first signal-to-noise ratio and the second signal-to-noise ratio.

2. The driver of claim 1, wherein the gain control apparatus is configured to perform gain amplification on the input signal of the driver based on an initial gain in an initialization stage of the driver; and the regulation apparatus is further configured to:
in the initialization stage, adjust the gain of the gain control apparatus within a preset fluctuation range of the initial gain to increase the second signal-to-noise ratio.

3. The driver of claim 1, wherein the gain control apparatus comprises:
a gain control module, wherein an input end of the gain control module is connected to the input end of the driver and a control end of the regulation apparatus respectively, an output end of the gain control module is connected to the output end of the driver, and the gain control module is configured to perform gain amplification on the input signal of the driver based on a gain given by the regulation apparatus; and
a feedforward equalizer, wherein the feedforward equalizer is connected to the gain control module, and the feedforward equalizer is configured to perform equalization processing on an input signal of the gain control module.

4. The driver of claim 3, wherein the feedforward equalizer comprises:
a filter unit corresponding to at least one frequency range, wherein the filter unit is connected to the gain control module, and the filter unit is configured to perform filtering processing on a signal in the corresponding frequency range in the input signal of the gain control module.

5. The driver of claim 3, wherein the gain control module comprises:
a first gain unit, wherein an input end of the first gain unit is connected to an output end of the feedforward equalizer and the control end of the regulation apparatus respectively, and the first gain unit is configured to perform first-stage gain amplification on the input signal of the driver based on a first gain given by the regulation apparatus to obtain a first-stage amplified signal; and
a second gain unit, wherein an input end of the second gain unit is connected to an output end of the first gain unit and the control end of the regulation apparatus respectively, an output end of the second gain unit is connected to the output end of the driver, and the second gain unit is configured to perform second-stage gain amplification on the first-stage amplified signal based on a second gain given by the regulation apparatus.

6. The driver of claim 5, wherein the feedforward equalizer comprises:
a first filter unit, wherein the first filter unit is connected to the first gain unit, and the first filter unit is configured to perform filtering processing on a signal in a first frequency range in an input signal of the first gain unit; and
a second filter unit, wherein the second filter unit is connected to the second gain unit, the second filter unit is configured to perform filtering processing on a signal in a second frequency range in an input signal of the second gain unit, and a frequency of the first frequency range is lower than a frequency of the second frequency range.

7. The driver of claim 1, wherein the driver further comprises:
a baseline wander correction apparatus, wherein the baseline wander correction apparatus is arranged between the input end of the driver and the gain control apparatus, and the baseline wander correction apparatus is configured to perform baseline wander correction on the input signal of the driver.

8. The driver of claim 1, wherein the driver further comprises:
a linear equalizer, wherein an input end of the linear equalizer is connected to the input end of the driver, an output end of the linear equalizer is connected to the first detection apparatus and an input end of the gain control apparatus respectively, and the linear equalizer is configured to perform pre-distortion processing on the input signal of the driver.

9. A control method for a driver of an optical module, wherein the control method is applied to a regulation apparatus in the driver, and the regulation apparatus is connected to a first detection apparatus, a gain control apparatus, and a second detection apparatus of the driver respectively; wherein the first detection apparatus is configured to detect a first signal-to-noise ratio of an input signal of the driver; the gain control apparatus is configured to perform gain amplification on the input signal of the driver; the second detection apparatus is configured to detect a second signal-to-noise ratio of an output signal of the driver; and the control method comprises:
adjusting a gain of the gain control apparatus based on the first signal-to-noise ratio and the second signal-to-noise ratio.

10. The control method of claim 9, wherein the adjusting the gain of the gain control apparatus based on the first signal-to-noise ratio and the second signal-to-noise ratio comprises:
in response that the first signal-to-noise ratio is greater than or equal to a preset threshold, acquiring a difference between the first signal-to-noise ratio and the second signal-to-noise ratio; and
in response that the difference exceeds a preset difference range, adjusting the gain of the gain control apparatus to reduce the difference.

11. The control method of claim 9, wherein the adjusting the gain of the gain control apparatus based on the first signal-to-noise ratio and the second signal-to-noise ratio comprises:
in response that the first signal-to-noise ratio and the second signal-to-noise ratio are both less than a preset threshold, adjusting the gain of the gain control apparatus to increase the second signal-to-noise ratio.

12. The control method of claim 9, wherein the gain control apparatus is configured to perform gain amplification on the input signal of the driver based on an initial gain in an initialization stage of the driver; and the control method further comprises:
in the initialization stage, adjusting the gain of the gain control apparatus within a preset fluctuation range of the initial gain to increase the second signal-to-noise ratio.

13. An optical module, comprising:
an input apparatus, configured to connect to a switch; a driver for an optical module, comprising:
a first detection apparatus, wherein the first detection apparatus is connected to an input end of the driver, and the first detection apparatus is configured to detect a first signal-to-noise ratio of an input signal of the driver;
a gain control apparatus, wherein the gain control apparatus is connected between the input end of the driver and an output end of the driver, and the gain control apparatus is configured to perform gain amplification on the input signal of the driver;
a second detection apparatus, wherein the second detection apparatus is connected to the output end of the driver, and the second detection apparatus is configured to detect a second signal-to-noise ratio of an output signal of the driver; and
a regulation apparatus, wherein the regulation apparatus is connected to the first detection apparatus, the second detection apparatus, and the gain control apparatus respectively, and the regulation apparatus is configured to adjust a gain of the gain control apparatus based on the first signal-to-noise ratio and the second signal-to-noise ratio; and
a laser, wherein a driving end of the laser is connected to an output end of the driver, and the laser is configured to emit an optical signal under the driving of an output signal of the driver.

14. An optical module, comprising:
an input apparatus, configured to connect to a switch;
the driver of claim 2; and
a laser, wherein a driving end of the laser is connected to an output end of the driver, and the laser is configured to emit an optical signal under the driving of an output signal of the driver.

15. An optical module, comprising:
an input apparatus, configured to connect to a switch;
the driver of claim 3; and
a laser, wherein a driving end of the laser is connected to an output end of the driver, and the laser is configured to emit an optical signal under the driving of an output signal of the driver.

16. An optical module, comprising:
an input apparatus, configured to connect to a switch;
the driver of claim 4; and
a laser, wherein a driving end of the laser is connected to an output end of the driver, and the laser is configured to emit an optical signal under the driving of an output signal of the driver.

17. An optical module, comprising:
an input apparatus, configured to connect to a switch;
the driver of claim 5; and
a laser, wherein a driving end of the laser is connected to an output end of the driver, and the laser is configured to emit an optical signal under the driving of an output signal of the driver.

18. An optical module, comprising:
an input apparatus, configured to connect to a switch;
the driver of claim 6; and
a laser, wherein a driving end of the laser is connected to an output end of the driver, and the laser is configured to emit an optical signal under the driving of an output signal of the driver.

19. An optical module, comprising:
an input apparatus, configured to connect to a switch;
the driver of claim 7; and
a laser, wherein a driving end of the laser is connected to an output end of the driver, and the laser is configured to emit an optical signal under the driving of an output signal of the driver.

20. An optical module, comprising:
an input apparatus, configured to connect to a switch;
the driver of claim 8; and
a laser, wherein a driving end of the laser is connected to an output end of the driver, and the laser is configured to emit an optical signal under the driving of an output signal of the driver.
